(19) United States
(12) Patent Application Publication
(10) Pub. No.: US 2023/0230374 A1
(43) Pub. Date: Jul. 20, 2023

(54) METHOD AND DEVICE FOR POSITIONING INTERNET OF THINGS DEVICES

(71) Applicant: BEIJING XIAOMI MOBILE SOFTWARE CO., LTD., Beijing (CN)

(72) Inventors: Mary-Luc Georges Henry CHAMPEL, Beijing (CN); Lei YU, Beijing (CN)

(73) Assignee: BEIJING XIAOMI MOBILE SOFTWARE CO., LTD., Beijing (CN)

(21) Appl. No.: 17/925,598

(22) PCT Filed: May 15, 2020
(86) PCT No.: PCT/CN2020/090695

§ 371 Date: Nov. 15, 2022

(51) Int. Cl. G06V 20/20; H04N 13/366; H04N 13/111; G16Y 40/60; G16Y 20/10; G16Y 10/80

(52) U.S. Cl. CPC G06V 20/20; G16Y 10/80; G16Y 20/10; G16Y 40/60; H04N 13/111; H04N 13/366

(57) ABSTRACT

A method for positioning an internet of things (IoT) device with AR glasses is provided. The method includes: acquiring an indoor map; determining an AR-position of the AR glasses on the indoor map and a viewing direction of the AR glasses based on initial information of the AR glasses; receiving from the AR glasses tracking information concerning the IoT device to be positioned; and determining an IoT-position of the loT device to be positioned from the AR-position and the viewing direction in combination with the tracking information of the AR glasses.

### CROSS REFERENCE TO RELATED APPLICATION

The present application is the U.S. national phase application of International Application No. PCT/CN2020/090695 filed on May 15, 2020, the entire content of which is incorporated herein by reference for all purposes.

### TECHNICAL FIELD

The present disclosure relates to a method for positioning an internet of things (IoT) device with an augmented reality (AR) glasses. Further, the present disclosure relates to a data processing device and a software for positioning of an IoT device.

### BACKGROUND

More and more objects in the home are now connected together and to the Internet. The connection to the internet of IoT devices in the home is usually done through a home network gateway which is in charge of routing messages between devices or from devices to outside of the home (through the internet) across many different types of networks such as Bluetooth, ZigBee or Wi-Fi.

### SUMMARY

According to a first aspect of the present disclosure, a method is provided for positioning an internet of things(IoT) device with AR glasses.

Furthermore, the method may include: acquiring an indoor map; determining an AR-position of the AR-glasses on the indoor map and a viewing direction of the AR glasses based on initial information of the AR glasses; receiving from the AR glasses tracking information concerning the IoT device to be positioned; and determining an IoT-position of the IoT device to be positioned from the determined AR-position and viewing direction in combination with the tracking information of the AR glasses.

According to a second aspect of the present disclosure, a data processing device is provided. The data processing device may include a processor and a memory storage, storing instructions which, when executed by the processor, are adapted to perform the method according to the first aspect.

According to a third aspect of the present disclosure, a non-transitory computer-readable storage medium storing processor-executed instructions is provided. The processor-executed instructions, when executed by a processor, cause the processor to perform the method according to the first aspect.

### BRIEF DESCRIPTION OF THE DRAWINGS

Reference will now be made, by way of example, to the accompanying drawings which show example embodiments of the present application, and in which the Figures show:

FIG. 1 illustrates a first embodiment of the method according to the present disclosure;

FIG. 2 illustrates an exemplified indoor map according to the present disclosure;

FIG. 3 illustrates a detailed embodiment of the method according to the present disclosure;

FIG. 4 illustrates a detailed embodiment for determining the AR-position and viewing direction of the AR glasses;

FIG. 5 illustrates a detailed embodiment of the method according to the present disclosure;

FIG. 6 illustrates a schematic drawing for determining the AR-position and viewing direction of the AR glasses according to the present disclosure;

FIG. 7 illustrates a schematic drawing for the calculation steps of the AR-position of the AR glasses;

FIG. 8 illustrates a detailed embodiment of the method according to the present disclosure;

FIG. 9 illustrates detailed embodiment of the method according to the present disclosure;

FIG. 10 illustrates an exemplified drawing for calculation of the IoT-position of the IoT device to be positioned; and

FIG. 11 illustrates a data processing device according to the present disclosure.

### DETAILED DESCRIPTION

The present application describes a method for determining the position of an IoT device on an indoor map, which is referred to in the following as IoT-position. Therein, AR glasses are used to position the IoT device. In order to be able to determine the IoT-position of the IoT device, in a first step, position and viewing direction of the AR glasses on the indoor map must be determined. Therein, in the following it is referred to the position AR glasses as AR-position.

From a user’s point of view, IoT devices are often controlled by at least one home automation system that is accessible both within the home (typically over Wi-Fi) or from outside the home (essentially over internet). It is not rare that multiple IoT devices belong to different home automation eco-systems and users sometimes have to juggle between different home automation applications or use bridge applications that are usually complex to set-up and do not offer all functionalities of the original home automation application.

Moreover, with the increasing number of IoT devices in the home, it becomes more and more tedious to quickly operate a single device from the home automation application.

A first solution that has been introduced in the prior art is to use voice control systems to control the IoT devices.

In any case the position of the IoT device is necessary in order to properly address the IoT device. Position indication of IoT devices is up to a certain degree present in every single home automation system today but it is always limited to just room categorizations. For instance, a connected light bulb may be identified as part of the living room but there is no information whatsoever about where exactly in the living room the light is. And if there are several lights, it becomes impossible to differentiate them unless the user has assigned them different names on purpose which need to be remembered by the user and distributed to all users of the home automation system.

Moreover, home automation systems usually have very little information about the spatial configuration of the home; at most it knows how many rooms are present. Only one IoT device today has such additional knowledge: the connected vacuum cleaner robot which typically performs a scan of the home to better define its sweeping path. But although such a home map or indoor map is generated, it is not shared with other devices or with the home automation system. In the future, it is also foreseen that other IoT devices such as video camera with ToF (Time-of-Flight) sensors will also be able to provide or at least help in building such indoor maps.

Thus, for better control of IoT devices, exact positions of the IoT devices are necessary. Positioning, i.e. the initial determination of the position of a new implemented IoT device, and subsequent locating the already positioned IoT devices become crucial for efficient control of home automation systems.

Hence, it is an object of the present disclosure to provide a method and a data processing device in order to position IoT devices.

Some IoT devices are already present in today’s home automation systems which generate an indoor map in order to perform their tasks. However, these maps are not shared with other IoT devices and are usually not shared with the home automation system. Thus, currently the exact position of IoT devices within the home automation system are not known or somehow utilized in order to control the IoT devices.

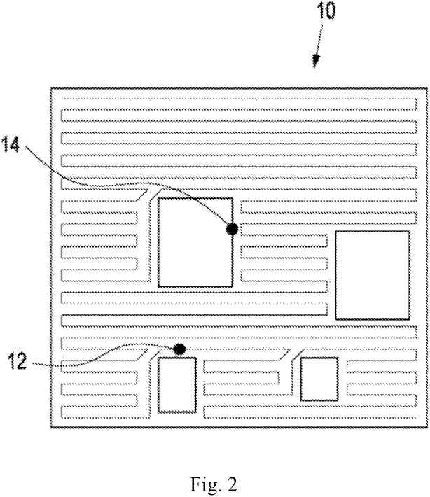

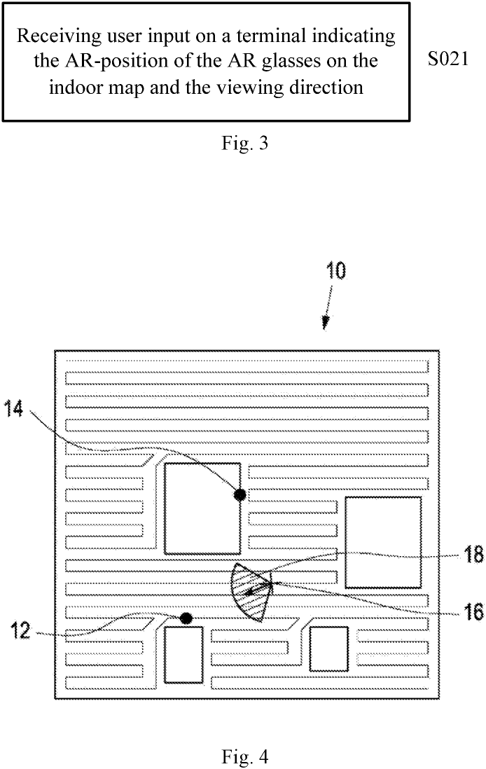

One of the IoT devices capable of creating an indoor map are vacuum cleaner robots. In many home automation systems, which include a vacuum cleaner robot, the robot has the capability to scan the home (typically with SLAM laser) and build a map of the home to fulfill their tasks. An example of an indoor map 10 is shown in FIG. 2. On the indoor map 10 a vacuum cleaner robot 12 is indicated and a docking station 14. Further, the indoor map exemplifies the moving trajectory of the vacuum cleaner robot 10 leading the vacuum cleaner robot around objects while cleaning the whole area. Such a map is typically only used by the robot vacuum cleaner in order to define an optimal sweeping path for the home while allowing users to have a clear representation of the path followed by the vacuum cleaner.

With the increasing number of IoT devices in the home, it becomes interesting to share such map between all IoT devices and position each of them on the map. This allows users to have a visual access to their devices through the home automation application rather than finding the IoT device in a list of rooms or devices.

For example, the home contains several light bulbs, a set of speakers, a TV set and a vacuum cleaner which can all be operated from the home automation application. Operating light bulbs is usually a tedious operation when there are several light bulbs in the home as the user first needs to identify precisely in the application which light bulb he wants to operate.

Thus, by using a map indicating the exact position of the IoT device such as a light bulb, it becomes possible to just point and click on the desired IoT device to activate, i.e. switch on, the IoT device.

The present disclosure provides a method for determining the IoT-position of IoT devices by an AR glasses. However, in order to determine the IoT-position of the IoT devices on the indoor map, first determining of the AR-position and viewing direction of the AR glasses on the indoor map must be performed. Once this is done, the tracking of the AR glasses in time can be performed due to one or more sensors in the AR glasses able to track motion of the AR glasses. Such sensor implemented in the AR glasses can be an accelerometer, a gyrometer, a compass or a video camera. In some examples, more than one and more, in some examples all of these sensors are implemented in the AR glasses combinedly.

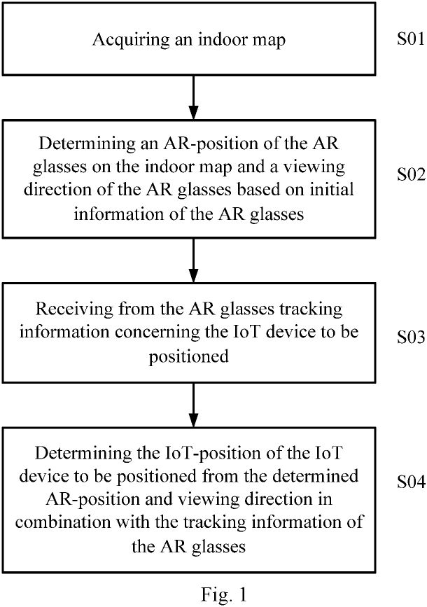

The method according to the present disclosure is shown schematically in FIG. 1 comprises the steps of:
S01: Acquiring an indoor map;
S02: Determining an AR-position of the AR glasses on the indoor map and a viewing direction of the AR glasses based on initial information of the AR glasses;
S03: Receiving from the AR glasses tracking information concerning the IoT device to be positioned; and
S04: Determining the IoT-position of the IoT device to be positioned from the determined AR-position and viewing direction in combination with the tracking information of the AR glasses.

In order to determine the AR-position and viewing direction of the AR glasses on the indoor map in a first solution the user can input on a terminal the AR-position of the AR glasses and the viewing direction directly on the indoor map. The method comprises the step S021: Receiving user input on a terminal indicating the AR-position of the AR glasses on the indoor map and the viewing direction.

As shown in FIG. 4 showing the exemplified indoor map 10 the AR glasses are at the AR-position 16 indicated by the “X” being directed towards the vacuum cleaner robot 12. Thus, the user may indicate on the indoor map 10 on his terminal device the AR-position 16 and also the viewing direction indicated by the arrow 18 by a user input, such as a click, touch and/or drawing input. Thus, the AR-position and the viewing direction of the AR glasses is known. A change of AR-position and viewing direction is tracked in real-time by the sensors of the AR glasses and change of AR-position and/or viewing direction of the AR glasses can be determined. Thus, once the AR glasses are located on the indoor map in combination with the viewing direction, this information can be used in order to position an IoT device in order to determine the IoT-position of this IoT device.

Therein it is not necessary to determine an absolute position of the AR glasses. Relative position with respect to the indoor map is sufficient.

Although in the foregoing it is described that the indoor map generated by a vacuum cleaner robot is used, any other indoor map generated by any other device, such as a surveillance camera or the like, can be used.

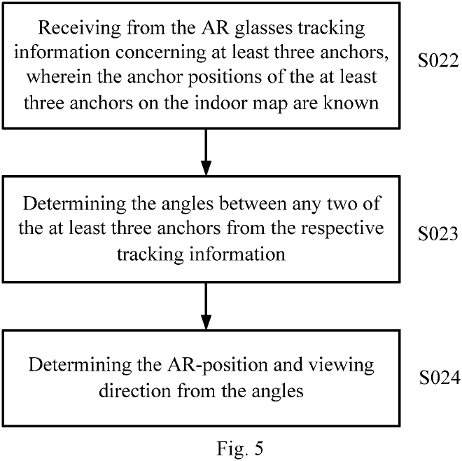

Referring now to a second solution for determining the AR-position and viewing direction of the AR glasses as schematically shown in FIG. 5 including the steps of:
S022: Receiving from the AR glasses tracking information concerning at least three anchors, wherein the anchor positions of the at least three anchors on the indoor map are known;
S023: Determining the angles between any two of the at least three anchors; and
S024: Determining the AR-position and viewing direction from the angles.

Thus, three anchors are used in order to determine the AR-position and the viewing direction of the AR glasses, wherein the position of the anchors on the indoor map 10 are known. Therein, the three anchors can be provided by IoT devices with a known position. In particular, if a vacuum cleaner robot 12 is present in the home automation system, then the docking station 14 of the vacuum cleaner robot 12 having a known position on the indoor map 10 might be used as one anchor; the vacuum cleaner robot 12 itself, having a known position on the indoor map 10, might be used as further anchor. Thus, only one additional anchor with known position is necessary in order to facilitate determination of the AR-position and viewing direction of the AR glasses.

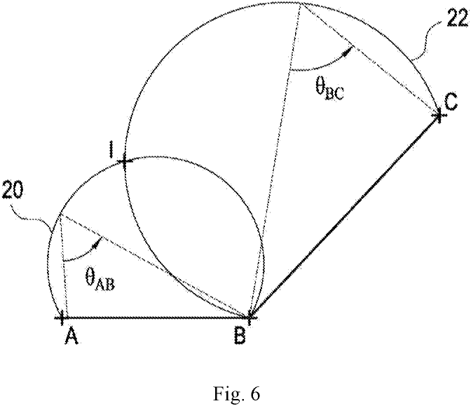

The situation is schematically depicted in FIG. 6 with a first anchor A, a second anchor B and a third anchor C, wherein the positions of the anchors A, B, C on the indoor map 10 are known. In order to determine the AR-position of the AR glasses, first an angle θ_{AB} between the anchor A and the anchor B is determined providing possible positions of the AR glasses on the first arc 20. Determination of the angle θ_{AB} might be provided by one or more of the sensors implemented in the AR glasses. Thus, the user first directs the AR glasses onto the anchor A, indicates the object of anchor A in order to identify anchor A to be able to retrieve the position of the anchor A on the indoor map. Then the user turns the head in order direct the AR glasses onto the anchor B, indicates the object of anchor B in order to be able to retrieve the position of anchor B on the indoor map. By turning the head and directing the AR glasses from the first anchor A to the second anchor B, the AR glasses are turned by the angle θ_{AB} that is determined and used for determining the AR-position and angle of the AR glasses. Therein, in some examples, the user remains at the same position.

The same steps for determining the angle θ_{AB} as described above are again performed for the anchors points B and C in order to determine the respective angle θ_{BC}. θ_{BC} provides a second arc 22 of a possible position of the AR glasses, wherein the intersection I of the first arc 20 and the second arc 22 indicates the AR-position of the AR glasses. From the AR-position of the AR glasses viewing direction towards one of the anchors A, B or C can be determined and thus AR-position and viewing direction of the AR glasses are fully determined.

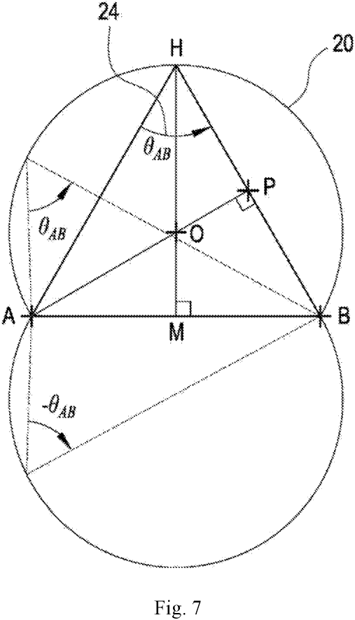

FIG. 7 shows a schematic situation with only two anchors for simplification illustrating the mathematical steps in order to determine the first arc 20. The method for determining the first arc 20 comprises the steps of:

1.) Consider point H in FIG. 7 as point on the median of the line segment AB (This means that the connecting line segment HM is perpendicular to the line segment AB and intersecting the line segment AB in the middle. Thus, an equilateral triangle ΔABH is created) on which the angle 24 (denoted as >AHB - the line segment AH being pivot around point H until overlapping the line segment HB) is equal to θ_{AB}. Therein, the direction of the angle is indicated by the arrow 24 and is defined here and in the following counter-clockwise as positive direction.

2.) The triangle ΔHBM with M being in the middle of AB is determined and the distance HM is calculated by

$$H M = \frac{1}{2} A B c o t \frac{{θ}_{A B}}{2} .$$

3.) In the triangle ΔHOP with P in the middle of the distance HB and the line segment OP perpendicular to the line segment HB, it is possible to calculate the distance HO being the radius of the first arc 20 with

$$cos \frac{{\text{θ}}_{A B}}{2} = \frac{H M}{H B} = \frac{H B / 2}{H O} ,$$

$$⇔ \text{} \text{HO} \text{=} \frac{\text{HB} / 2}{cos \frac{{\text{θ}}_{\text{AB}}}{2}} .$$

4.) The distance HM expressed using HO is given by

$$H M = 2 H O c o {s}^{2} \frac{{θ}_{A B}}{2}$$

By using the relation HM = HB cos θ_{AB} given from FIG. 7.

5.) Then the distance OM can be calculated by

$$O M = H M - H O ,$$

inserting the formulas for HM and HO gives

$$O M = \frac{1}{2} A B c o t {θ}_{A B} .$$

Thereby the trigonometric identities sin2θ=2sinθcosθ and cos2θ=2cos²θ-1 are used.

Thus, the position of point O is known due to knowledge of the length OM and knowledge of point M. Further, the radius HO for the first arc 20 passing through the points A, B and H is known as well. Thus, it is possible to calculate the quadric equation for the first cycle 20. The same steps are repeated for the anchor B and anchor C in order to calculate the quadric equation for the second cycle 22 as shown in FIG. 6. Thus, the system of the two quadric equations for the first arc 20 and the second arc 22 is solved providing two solutions: B and the actual position of the AR glasses indicated by the intersection I of the first cycle 20 and the second cycle 22.

As shown in FIG. 7 with knowledge only of the value of θ_{AB} two possible first arcs 20 and 20′ exist. However, if the direction/sign of the angle θ_{AB} is known, the first arc becomes unique. As indicated in FIG. 7, if the angle with direction is determined as +θ_{AB}, then arc 20 is determined as first arc. If the angle with direction is determined as -θ_{AB}, then the arc 20′ would uniquely indicate possible AR-positions of the AR glasses. Thus, by the direction of the angle no ambiguity arises for the first arc 20 and similar also the second arc 22. Thus, also the intersection I provides a unique solution. In some examples, the direction of the angles are determined by one of the sensors in the AR glasses and/or the compass information.

However, even if the directions of the angles between the anchors are not known, it is still possible to determine a solution for the AR-position of the AR glasses. If the AR glasses are not positioned at the anchor B or at least not to close and the angle >ABC between the anchors is larger than 0° and smaller than 180°, then the point of intersection I of the two arcs 20, 22 far away from anchor B is the position of the AR glasses.

Alternatively, a fourth anchor need to be used to provide a unique solution for the position of the AR glasses on the indoor map.

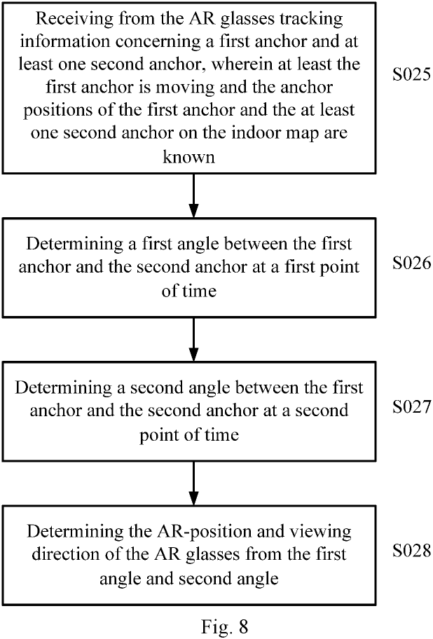

In some examples, if one of the anchors is provided by the vacuum cleaner robot 12 moving with known position, the vacuum cleaner robot 12 can be used as first anchor as described above at a first point of time and as second anchor at a second point of time. Thus, the method to determine the AR-position and the viewing direction of the AR glasses is shown in FIG. 8 and includes the steps of:
S025: Receiving from the AR glasses tracking information concerning a first anchor and at least one second anchor, wherein at least the first anchor is moving and the anchor positions of the first anchor and the at least one second anchor on the indoor map are known;
S026: Determining a first angle between the first anchor and the second anchor at a first point of time;
S027: Determining a second angle between the first anchor and the second anchor at a second point of time, wherein the anchor position of at least the first anchor at the second point of time is different to the anchor position of at least the first anchor at the first point of time; and
S028: Determining the AR-position and viewing direction of the AR glasses from the first angle and second angle.

Thus, it is sufficient to have a vacuum cleaner robot 12 that is moving and the docking station 14 having both a known position on the indoor map in order to facilitate determination of the AR-position and the viewing direction of the AR glasses.

In some embodiments dedicated AR markers are used on at least one, more than one or all of the IoT devices in the home. With the help of such AR markers, it becomes unnecessary for the user to identify which IoT devices he is currently looking at since the AR marker will provide that information and uniquely identifies the IoT device. Consequently, only by browsing the home, AR glasses will easily detect IoT devices and identify them due to their AR marker. Once this is done, the home automation system can determine the position of the AR glasses by mathematically compute it from the IoT-position of the IoT devices with AR markers and the viewing angles between them reported by the AR glasses as described above. Alternatively, the IoT-position of a single IoT device can also be computed by looking at it from two different positions of the AR glasses when compass information is available or three different positions of the AR glasses if only angle information (between the different viewing positions) is known.

The obvious advantage of this solution is that not only it is fully automatic, but this can also be fully transparent for the user provided there are enough (at least 3) IoT devices in the home that AR glasses can recognize and for which the positions on the map are known. The only thing required for this solution is to attach AR markers to the IoT devices. Such AR markers could be provided by the IoT manufacturer or downloaded later.

In another embodiment of this disclosure, the above mentioned embodiments can also be used to help with the real-time tracking of the AR glasses in the home by always having the positioning of the AR glasses running in the background.

In another embodiment at least one, more than one or all IoT devices are identified with object recognition techniques. Indeed, for some IoT devices, it is possible to use machine learning techniques and train AR glasses software in recognizing specific IoT devices. This has the obvious advantage of being a fully automatic and fully transparent solution.

In some embodiments the AR glasses include a compass in order to acquire compass information. Then, in a first step then compass information is connected to the indoor map and provide an absolute orientation of the indoor map with respect to the compass information. To do so, the first time the AR-position and viewing direction of the AR glasses is determined, the compass information is recorded with regards to this position.

Then later, whenever the AR-position and the viewing direction of the AR glasses are determined, the compass information can be used and being synchronized with the oriented map of the home to better position the AR glasses and increase accuracy. Further, if compass information is present, only two anchor points are required to uniquely identify the AR-position I of the AR glasses. The use of a third anchors can nevertheless bring more precision.

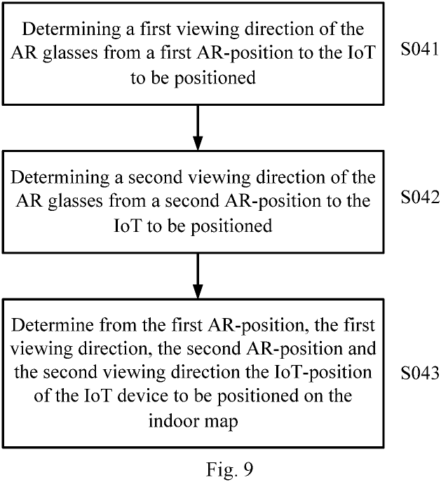

FIG. 9 shows an embodiment for positioning the IoT device including the steps of:

S041: Determining a first viewing direction of the AR glasses from a first AR-position to the IoT to be positioned.

S042: Determining a second viewing direction of the AR glasses from a second AR-position to the IoT to be positioned.

S043: Determine from the first AR-position, the first viewing direction, the second AR-position and the second viewing direction the IoT-position of the IoT device to be positioned on the indoor map.

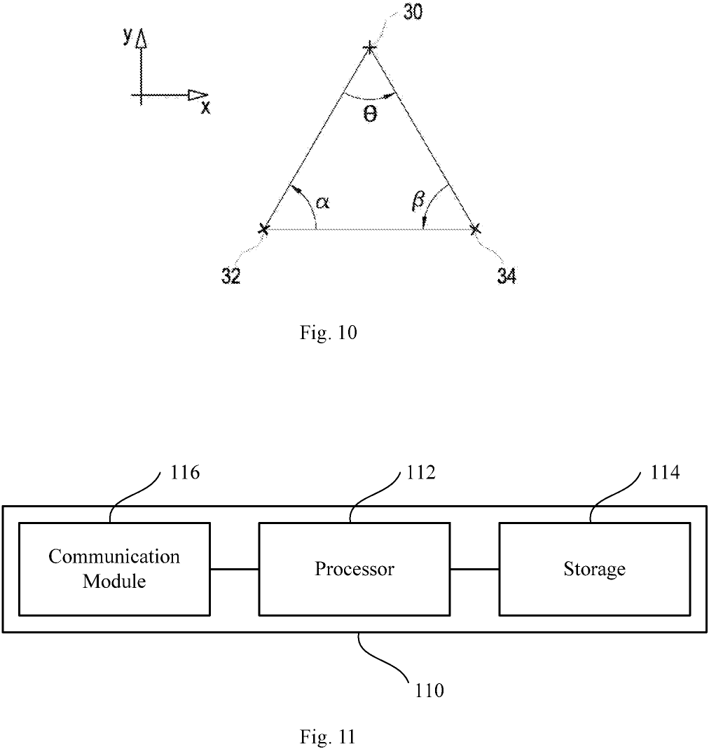

FIG. 10 shows schematically the situation for an IoT device 30 to be positioned. By the AR glasses having a known AR-position and viewing direction, from a first AR-position 32 a viewing direction as an angle α is determined with a compass. Afterwards from a second AR-position 34 a second viewing direction towards the IoT device 30 to be positioned is determined. Thus, by the first AR-position 32, the second AR-position 34, the first viewing direction α, and the second viewing direction β the IoT-position of the IoT device 30 can be determined with a compass. This, position can be assigned to the IoT device and stored for further usage. If the IoT device 30 is positioned on the indoor map 10 then the IoT device 30 can be used as anchor in order to determine the AR-position and viewing direction of the AR glasses.

If compass information is not available, only ⊝ angle (the viewing angle between the two viewing positions) is known and a third viewing AR-position is needed to compute IoT device actual IoT-position. This is the same process used as for computing AR glasses AR-position of the AR glasses as described hereinbefore.

In some examples, a method is provided for positioning an internet of things, IoT, device with AR glasses, including the steps of: acquiring an indoor map; determining an AR-position of the AR-glasses on the indoor map and a viewing direction of the AR glasses based on initial information of the AR glasses; receiving from the AR glasses tracking information concerning the IoT device to be positioned; and determining an IoT-position of the IoT device to be positioned from the determined AR-position and viewing direction in combination with the tracking information of the AR glasses.

Therein, augmented reality is a real environment experience in which additional information is represented with virtual elements such as graphics, videos, animations, and the like. Therein, the virtual elements are provided by the AR glasses to the user via visual perception.

Further, IoT devices encompass all kinds of small/personal devices that are connected to the internet. This may include home devices such as light bulbs, televisions, vacuum cleaner and its docking station, sound devices, smart TVs, kitchen devices and the like but is not limited in the present disclosure. The IoT devices may provide different functionalities which can be controlled via the internet connection. Usually a software application is running on a terminal user, providing connectivity to the functions of the IoT devices.

Further, the indoor map is a map of a home indicating the relative positions between objects on the indoor map. Thus, an indoor map is acquired which is used for determining the AR-position and a viewing direction of the AR glasses on the indoor map, wherein the AR-position and viewing direction of the AR glasses are based on initial information of the AR glasses. In some examples, the AR glasses comprise at least one sensor in order to acquire the initial information. The at least one senor can be a compass, a gyrometer and/or an accelerometer in order to determine movement/rotation of the AR glasses and in particular a rotation angle at least in the horizontal plane. Thus, by the sensor in the AR glasses in some examples an angle can be determined between a first viewing direction and second viewing direction as initial information in order to determine the AR-position on the indoor map and the viewing direction of the AR glasses.

In order to determine the IoT-position of an IoT device, the AR glasses receives tracking information concerning the respective IoT device to be positioned. Therein, in some examples to acquire the tracking information the AR glasses are directed onto the IoT device by the user by looking at or in the direction of the IoT device to be positioned. From the AR-position and the viewing direction of the AR glasses in combination with the acquired tracking information concerning the IoT device to be positioned acquired by the AR glasses, the IoT-position of the IoT device to be positioned is determined.

Thus, the AR glasses are used to determine the IoT-position of the IoT device on the indoor map. However, in order to be able to determine the IoT-position of the IoT device, first the AR-position and the viewing direction of the AR glasses on the indoor map need to be determined by the initial information of the AR glasses. Thus, positioning of the IoT device is simplified and it is not necessary anymore to manually position the IoT device on an indoor map or somehow assign the position of the IoT device to the IoT device manually. Thus, correctly positioned IoT devices can be easier addressed to be controlled. In particular, it would be able to indicate the IoT device directly on the user’s terminal on the indoor map. Thus, for example identical IoT devices (two light bulbs in one room) can be easily distinguished and appropriately addressed and controlled by the user.

In some examples, determining an AR-position of the AR glasses on the indoor map and a viewing direction of the AR glasses based on initial information of the AR glasses comprises:

Receiving user input on a terminal indicating the AR-position of the AR glasses on the indoor map and the viewing direction.

Thus, by the user input the AR-position of the AR glasses on the indoor map are provided. The user input can be a touch input or any other clicking or marking input of the position on the terminal. In some examples, the AR-position is indicated directly on the indoor map displayed by the terminal. Further, the current viewing direction can be input by indicating on the terminal an object in the current field of view of the user or by drawing on the terminal starting from the AR-position of the AR glasses into the direction of the viewing direction. In some examples, the viewing direction is indicated directly on the indoor map displayed by the terminal. Thus, by the user input on the terminal the AR-position and viewing direction of the AR glasses are easily provided which can be used in order to determine the IoT-position of the IoT device to be positioned.

In some examples, determining an AR-position of the AR glasses on the indoor map and a viewing direction of the AR glasses based on initial information of the AR glasses comprises:

Receiving from the AR glasses tracking information concerning at least three anchors, wherein the anchor positions of the at least three anchors on the indoor map are known;

Determining angles between any two of the at least three anchor points from the respective tracking information; and

Determining the AR-position and viewing direction of the AR glasses from the angles.

In some examples, the tracking information of the at least three anchors are received from the AR glasses while the AR glasses remaining at the same position. Thus, the position of the AR glasses is fixed while only the viewing direction of the AR glasses is changed in order to receive the tracking information of the at least three anchors. Therein, anchors can be any point in the real environment of the user, wherein the position of the anchors on the indoor map are known. By looking at one of these anchors tracking information is received by the AR glasses. In some examples, as tracking information received by the AR glasses angles between the at least three anchor points are determined. Thus, at least two angles are determined, i.e. a first angle between the first and second anchor and a second angle between the second and third anchor. In some examples, these angles are determined by the accelerometer or gyrometer implemented in the AR glasses. From the determined angles the AR-position and the viewing direction of the AR glasses can be determined.

In some examples, determining an AR-position of the AR glasses on the indoor map and a viewing direction of the AR glasses based on initial information of the AR glasses comprises: receiving from the AR glasses tracking information concerning a first anchor and at least one second anchor, wherein at least the first anchor is moving and anchor positions of the first anchor and the at least one second anchor on the indoor map are known;
determining a first angle between the first anchor and the second anchor at a first point of time;
determining a second angle between the first anchor and the second anchor at a second point of time, wherein the anchor position of at least the first anchor at the second point of time is different to the anchor position of at least the first anchor at the first point of time;
determining the AR-position and viewing direction of the AR glasses from the first angle and second angle.

Thus, the first anchor is moving while knowing the anchor position on the indoor map. The tracking information of the first anchor can be used at a first point of time and a second point of time in order determine a first angle and a second angle, wherein from the angles the AR-position and viewing direction of the AR glasses can be determined. Thus, only two anchors are necessary, while at least one anchor is moving with a known position on the indoor map.

In some examples, determining the angles between the aby of the at least three anchors comprises: Determining the direction/sign of the angle between two of the anchors. Thus, initial information is acquired whether the angle between two of the anchors is determined by a rotation of the AR glasses from left to right or right to left. This additional information can be used for determining the position and viewing direction of the AR glasses. Therein, in some examples the direction (or mathematically, the sign) of the angle is determined on the basis of sensor data like sensor data of the gyrometer, accelerometer or compass of the AR glasses.

In some examples, at least one anchor comprises an AR marking to be recognized by the AR glasses in order to identify the anchor. Thus, automatic or at least semi-automatic recognition of the anchor can be facilitated. By the AR marking the anchor is uniquely identified. Hence, the position of the anchor on the indoor map can be assigned to the AR marking automatically recognized by the AR glasses.

In some examples, at least one anchor is identified by the AR glasses by image recognition. Thus, automatic or at least semi-automatic recognition of the anchors can be facilitated. Therein, anchors can be provided by unique objects in a home such as a television, a fridge, an oven or the like. These objects might be recognized by the AR glasses and then used as anchors in order to determine the position and the viewing direction of the AR glasses.

In some examples, compass information of the AR glasses is determined, and the indoor map is oriented according to the compass information. In some examples, the AR glasses comprises a compass in order to generate compass information which can be used to provide an orientation of the indoor map that usually does not include any compass information. Then, the indoor map is oriented according to the compass information and the orientation of the indoor map is fixed for further use. Subsequent determination of the position and the viewing direction of the AR glasses can then be facilitated by the correctly orientated indoor map. Thereby, determining the position and the viewing direction of the AR glasses can be simplified or the accuracy of the position and viewing direction can be enhanced by the additional compass information.

In some examples, determining an AR-position of the AR glasses on the indoor map and a viewing direction of the AR glasses based on initial information of the AR glasses comprises: Using the compass information in order to determine angles between at least two anchors and/or direction of each angle between any two of at least two anchors.

In some examples, the anchors are provided by one or more IoT devices. Thus, in some examples the IoT devices are marked with AR markings. These AR markings can be in particular provided by the manufacturer of the IoT devices to simplify the positioning of the IoT devices. Similarly, the appearance of the IoT devices are known to the manufacturer of the IoT devices wherein this information can be used by the image recognition in order to recognize automatically the IoT devices by the AR glasses.

In some examples, the indoor map is provided by a vacuum cleaner and/or a surveillance camera. In some examples, the surveillance camera is any camera including a Time-of-Flight camera, a stereo camera or any other optical device providing 3D information, such as LIDAR (light detecting and ranging) or the like.

In some examples, determining an IoT-position of the IoT device to be positioned from the determined AR-position and viewing direction in combination with the tracking information of the AR glasses comprises: Determine a first viewing direction of the AR glasses from a first AR-position to the IoT to be positioned;

Determine at least a second viewing direction of the AR glasses from a second AR-position to the IoT to be positioned; and

Determine from the first AR-position, the first viewing direction, the second AR-position and the second viewing direction the IoT-position of the IoT device to be positioned on the indoor map.

In some examples, a third viewing direction of the AR glasses from a third AR-position to the IoT to be positioned is used in addition, in particular if compass information is not available. In this case the IoT-position of the IoT device is determined analogously to the steps of determining the AR-position of the AR glasses as described above and below. Thus, by the AR glasses with known AR-position and viewing direction, positioning of an IoT device with unknown position on the indoor map is facilitated. This IoT-position of the IoT device can be assigned to the IoT device, used for control of the IoT device and/or stored. In some examples, if the IoT-position of an IoT device is determined, this IoT device can be used as anchor for further determination of an AR-position and viewing angle of the AR glasses.

In some examples, determining the IoT-position of the IoT device to be positioned from the determined AR-position and viewing direction in combination with the tracking information of the AR glasses comprises: Using the compass information in order to determine the first viewing direction and the second viewing direction.

Thus, by the present disclosure positioning of an IoT device is facilitated by use of AR glasses. Therein, first the AR-position and the viewing direction of the AR glasses on an acquired indoor map is determined and this information is used to determine the IoT-position of the IoT device to be positioned. Thus, it is not necessary anymore to manually indicate the position of the IoT device. By the known IoT-position of the IoT device control of the IoT devices within a home automation application can be easily controlled and identification within the home automation application of the individual IoT devices is simplified due to the determined IoT-position. Thus, even if same or similar IoT devices are present in just one room more than once, these IoT devices can be clearly distinguished by their exact position.

FIG. 11 shows a device 110 comprising a processor 112 wherein the processor 112 is connected to a storage 114. The storage 114 stores instructions which when carried out by the processor 112 implement the steps of the method as previously described. Further, the processor 112 is connected to a communication module 116 in order to receive tracking information view directions compass information or the like from the AR glasses. Therein data transmission might be performed wireless via WLAN, WIFI, GSM, 3G, 4G, 5G, Bluetooth, ZiggBee or any other standard.

Alternatively, instead of the communication module 116 the processor 112 and the storage 114 of the device 110 are directly connected to the AR glasses as one device.

In some examples, the processor can be any general-purpose processor, an ASIC, FPGA or any other kind of processing unit.

In some examples, the device 110 is a data processing device which is connected to an AR glasses to receive tracking information of the AR glasses in order to determine the AR-position and the viewing direction of the AR glasses and/or viewing directions in order to position an IoT device.

In some examples, the device is a terminal such as a smartphone, tablet, laptop or any other kind of devices. In particular, the device also includes a display to display the indoor map. Then, the IoT devices can be display at their respective positions on the indoor map. By interacting with the representation of the IoT devices on the terminal, the respective IoT devices in the home automation system are controlled.

Thus, by the present disclosure real time positioning and tracking of AR glasses worn by a user on an indoor map is enabled. By the AR glasses IoT devices can be positioned. By the precise IoT-position of the IoT device control of the IoT devices is simplified. In particular, an indoor map can be displayed on a terminal indicating the IoT devices on the indoor map wherein the IoT-positions of each IoT device is determined according to the present disclosure. Then, the IoT devices are easily accessible via the position on the indoor map.

1. A method of positioning an internet of things (IoT) device with augmented reality (AR) glasses, comprising:
acquiring an indoor map;
determining an AR-position of the AR glasses on the indoor map and a viewing direction of the AR glasses based on initial information of the AR glasses;
receiving, from the AR glasses, tracking information concerning the IoT device to be positioned; and
determining an IoT-position of the IoT device to be positioned from the AR position and the viewing direction in combination with the tracking information of the AR glasses.

2. The method according to claim 1, wherein the initial information of the AR glasses comprises:
receiving user input on a terminal indicating the AR-position of the AR glasses on the indoor map and the viewing direction.

3. The method according to claim 1, wherein determining the AR-position of the AR glasses on the indoor map and the viewing direction of the AR glasses based on the initial information of the AR glasses comprises:
receiving from the AR glasses second tracking information concerning at least three anchors, wherein anchor positions of the at least three anchors on the indoor map are known;
determining angles between any two of the at least three anchors from the respective tracking information; and
determining the AR-position and the viewing direction of the AR glasses from the angles.

4. The method according to claim 1, wherein determining the AR-position of the AR glasses on the indoor map and the viewing direction of the AR glasses based on the initial information of the AR glasses comprises:
receiving from the AR glasses third tracking information concerning a first anchor and at least one second anchor, wherein at least the first anchor is moving and anchor positions of the first anchor and the at least one second anchor on the indoor map are known;
determining a first angle between the first anchor and the second anchor at a first point of time;
determining a second angle between the first anchor and the second anchor at a second point of time, wherein an anchor position of at least the first anchor at the second point of time is different to an anchor position of at least the first anchor at the first point of time; and
determining the AR-position and the viewing direction of the AR glasses from the first angle and the second angle.

5. The method according to claim 3, wherein determining the angles between any two of the at least three anchors comprises:
determining a direction, a sign, or the direction and the sign of an angle between two of the at least three anchors.

6. The method according to claim 3, wherein at least one anchor comprises an AR marking to be recognized by the AR glasses in order to identify the at least one anchor.

7. The method according to claim 3, wherein at least one anchor is identified by the AR glasses by image recognition.

8. The method according to claim 1, wherein compass information of the AR glasses are determined and the indoor map is oriented according to the compass information.

9. The method according to claim 8, wherein determining the AR-position of the AR glasses on the indoor map and the viewing direction of the AR glasses based on the initial information of the AR glasses comprises:
using the compass information in order to determine angles between at least two anchors or a direction of each angle between any two of the at least two anchors.

10. The method according to claim 3, wherein the at least three anchors are provided by one or more IoT devices.

11. The method according to claim 1, wherein the indoor map is provided by a vacuum cleaner and/or a surveillance camera.

12. The method according to claim 1, wherein determining the IoT-position of the IoT device to be positioned from the AR-position and the viewing direction in combination with the tracking information of the AR glasses comprises:
determining a first viewing direction of the AR glasses from a first AR-position to the IoT device to be positioned;
determining at least a second viewing direction of the AR glasses from a second AR-position to the IoT device to be positioned; and
determining, from the first AR-position, the first viewing direction, the second AR-position and the second viewing direction, the IoT-position of the IoT device to be positioned on the indoor map.

13. A data processing device comprising a processor and a memory storage, storing instructions which, when executed by the processor, cause the processor to:
acquire an indoor map;
determine an augmented reality-position (AR-position) of an AR glasses on the indoor map and a viewing direction of the AR glasses based on initial information of the AR glasses, wherein an internet of things (IoT) device comprises the AR glasses,
receive from the AR glasses tracking information concerning the IoT device to be positioned; and
determine an lot-position of the IoT device to be positioned from the AR-position and the viewing direction in combination with the tracking information of the AR glasses .

14. A non-transitory computer-readable storage medium storing processor-executed instructions that, when executed by a processor, cause the processor to perform acts comprising:
acquiring an indoor map;
determining an augmented reality-position (AR-position) of an AR glasses on the indoor map and a viewing direction of the AR glasses based on initial information of the AR glasses,
receiving from the AR glasses tracking information concerning the IoT device to be positioned; and
determining an lot-position of the IoT device to be positioned from the AR-position and the viewing direction in combination with the tracking information of the AR glasses .

15. The data processing device according to claim 13, wherein the processor is further configured to:
receive user input on a terminal indicating the AR-position of the AR glasses on the indoor map and the viewing direction.

16. The data processing device according to claim 13, wherein the processor is further configured to:
receive from the AR glasses second tracking information concerning at least three anchors, wherein the anchor positions of the at least three anchors on the indoor map are known;
determine angles between any two of the at least three anchors from the respective tracking information; and
determine the AR-position and the viewing direction of the AR glasses from the angles.

17. The data processing device according to claim 13, wherein the processor is further configured to:
receive from the AR glasses third tracking information concerning a first anchor and at least one second anchor, wherein at least the first anchor is moving and anchor positions of the first anchor and the at least one second anchor on the indoor map are known;
determine a first angle between the first anchor and the second anchor at a first point of time;
determine a second angle between the first anchor and the second anchor at a second point of time, wherein an anchor position of at least the first anchor at the second point of time is different to an anchor position of at least the first anchor at the first point of time; and
determine the AR-position and the viewing direction of the AR glasses from the first angle and the second angle.

18. The data processing device according to claim 16, wherein the processor is further configured to:
determine a direction, a sign, or the direction and the sign of an angle between two of the at least three anchors.

19. The data processing device according to claim 16, wherein at least one anchor comprises an AR marking to be recognized by the AR glasses in order to identify the at least one anchor.

20. The data processing device according to claim 16, wherein at least one anchor is identified by the AR glasses by image recognition.
